(19) United States
(12) Patent Application Publication
(10) Pub. No.: US 2015/0170586 A1
(43) Pub. Date: Jun. 18, 2015

(54) DATA DRIVER AND DISPLAY DEVICE

(71) Applicant: Samsung Display Co., Ltd., Yongin-City (KR)

(72) Inventor: Gil Jae Lee, Yongin-si (KR)

(21) Appl. No.: 14/340,323

(22) Filed: Jul. 24, 2014

(30) Foreign Application Priority Data
Dec. 17, 2013 (KR) 10-2013-0157431

(51) Int. Cl. G09G 3/36; G09G 3/32

(52) U.S. Cl. CPC G09G 3/3607; G09G 3/3696; G09G 3/3258; G09G 2310/027

(57) ABSTRACT

A data driver of a display device is disclosed. In one aspect, the display device includes a signal line connected to a pixel. A gray voltage generator generates a plurality of gray voltages that correspond to a plurality of grayscale values. A binary decoder selects a gray voltage that corresponds to input data from among the plurality of gray voltages, and a buffer includes an input terminal connected to an output terminal of the binary decoder and an output terminal connected to the signal line.

### CROSS-REFERENCE TO RELATED APPLICATIONS

This application claims priority under 35 U.S.C. §119 to Korean Patent Application No. 10-2013-0157431 filed in the Korean Intellectual Property Office on Dec. 17, 2013, the entire contents of which are incorporated herein by reference.

### BACKGROUND

1. Field

The described technology generally r relates to a display device and a data driving device including a gray voltage generator.

2. Description of the Related Technology

Active display devices such as an organic light emitting diode (OLED) display and a liquid crystal display (LCD) include a plurality of pixels defined by a plurality of scan lines extended in a row direction and a plurality of data lines extended in a column direction. A scan driving device sequentially applies a scan pulse to a plurality of scan lines and a data driving device applies data to a plurality of data lines to write desired data to the pixels and display an image.

The data driving device uses a decoder to select a gray voltage that corresponds to an input grayscale value from among a plurality of gray voltages, and applies the selected gray voltage as data to the corresponding data line. Traditionally, when there are N gray voltages, an N×1 decoder for selecting one of the N gray voltages is used for each data line; therefore, many circuit elements for implementing the decoder are needed. Accordingly, the existence of numerous circuit elements increases the area of the decoder. Additionally, voltage drops across these numerous circuit elements cause imperfections in displaying the gray values.

The above information in the Background section is only for enhancement of understanding of the background of the technology and therefore it should not be construed as admission of existence or relevancy of the prior art.

### SUMMARY OF CERTAIN INVENTIVE ASPECTS

One inventive aspect is a data driving device of a display device including a signal line connected to a pixel.

The data driving device can include, a gray voltage generator for generating a plurality of gray voltages that correspond to a plurality of grayscale values; a binary decoder for selecting from among the plurality of gray voltages a gray voltage that corresponds to an input data; and a buffer including an input terminal electrically connected to an output terminal of the binary decoder and an output terminal electrically connected to the signal line.

The data driving device can further include a shunt regulator electrically connected to an output terminal of the binary decoder.

The data driving device can further include a shunt regulator electrically connected to an output terminal of the buffer.

The input data can include a plurality of bits.

the binary decoder can include an input switch group, at least one interposed switch group, and an output switch group; wherein the input switch group, the at least one interposed switch group and the output switch group are coupled in series between an output terminal of the gray voltage generator and an input terminal of the buffer, each switch group corresponding to the plurality of bits.

the input switch group selects half of the gray voltages of the plurality of gray voltages and outputs the same to the at least one interposed switch group in response to a bit corresponding to the input switch group.

Each switch group in the at least one interposing switch group selects half of the gray voltages of the plurality of gray voltages inputted from a previous switch group and outputs the selected gray voltages to a next switch group in response to a bit corresponding to the each switch group, and

the output switch group selects half of the gray voltages inputted from the at least one interposed switch group and outputs the selected gray voltage to the input terminal of the buffer in response to a bit corresponding to the output switch group.

each switch group includes at least one switch that corresponds to two gray voltages, and the switch selects one of the two gray voltages in response to the bit corresponding to the switch group.

Each switch can include, a first transistor electrically connected between a first input terminal for receiving a first gray voltage from among the two gray voltages and an output terminal, and the first transistor is turned on when the bit corresponding to the switch group is “1”; and a second transistor electrically connected between a second input terminal for receiving a second gray voltage from among the two gray voltages and the output terminal, and the second transistor is turned on when the bit corresponding to the switch group is “0”.

In another aspect, the switch can include, a first n-channel transistor and a first p-channel transistor coupled in parallel between a first input terminal for receiving a first gray voltage from among the two gray voltages and an output terminal, and the first n-channel transistor and the first p-channel transistor are turned on when the bit corresponding to the switch group is “1”; and a second n-channel transistor and a second p-channel transistor coupled in parallel between a second input terminal for receiving a second gray voltage from among the two gray voltages and the output terminal, and the second n-channel transistor and the second p-channel transistor are turned on when the bit corresponding to the switch group is “0”.

In one aspect, the plurality of bits can be in order of a least significant bit (LSB), a most significant bit (MSB), LSB+1, MSB−1, LSB+2, MSB−2, . . . , LSB+(MSB/2−1), and MSB-(MSB/2−1).

In another aspect, the plurality of bits can be in order of MSB, MSB−1, MSB−2, . . . , LSB+1, and LSB.

In another aspect, the plurality of bits can be in order of MSB/2, MSB/2+1, MSB/2+2, . . . , MSB, LSB, LSB+1, LSB+2, . . . , and (MSB/2−1).

In another aspect, the data driving device can include: a gray voltage generator for generating a plurality of gray voltages that correspond to a plurality of grayscale values; a decoder for selecting from among the plurality of gray voltages a gray voltage that corresponds to an input data; a buffer including an input terminal electrically connected to an output terminal of the decoder and an output terminal electrically connected to the signal line; and a shunt regulator electrically connected between the output terminal of the decoder and the input terminal of the buffer.

Yet in another embodiment a display device can include, a pixel; a signal line connected to the pixel; a gray voltage generator for generating a plurality of gray voltages that correspond to a plurality of grayscale values; a decoder for selecting from among the plurality of gray voltages a gray voltage that corresponds to an input data; a buffer including an input terminal electrically connected to an output terminal of the decoder and an output terminal electrically connected to the signal line; and a shunt regulator electrically connected between an output terminal of the decoder and the input terminal of the buffer.

### BRIEF DESCRIPTION OF THE DRAWINGS

FIG. 1 shows a block diagram of a display device according to an exemplary embodiment.

FIG. 2, FIG. 3, FIG. 9, and FIG. 10 show block diagrams of a data driving device according to various exemplary embodiments.

FIG. 4, FIG. 7, and FIG. 8 show a decoder of a data driver according to various exemplary embodiments.

FIG. 5 shows an example of a switch included in a decoder shown in FIG. 4.

FIG. 6 shows another example of a switch included in a decoder shown in FIG. 4.

### DETAILED DESCRIPTION OF CERTAIN INVENTIVE EMBODIMENTS

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Example embodiments will now be described more fully hereinafter with reference to the accompanying drawings. However, the described embodiments may be embodied in different forms and should not be construed as limited to the embodiments set forth herein. Rather, these embodiments are provided so that this disclosure will be thorough and complete and will fully convey the scope of the described technology to those skilled in the art.

In the figures, dimensions may be exaggerated for clarity of illustration. It will be understood that when an element is referred to as being “between” two elements, it can be the only element between the two elements, or one or more intervening elements may also be present.

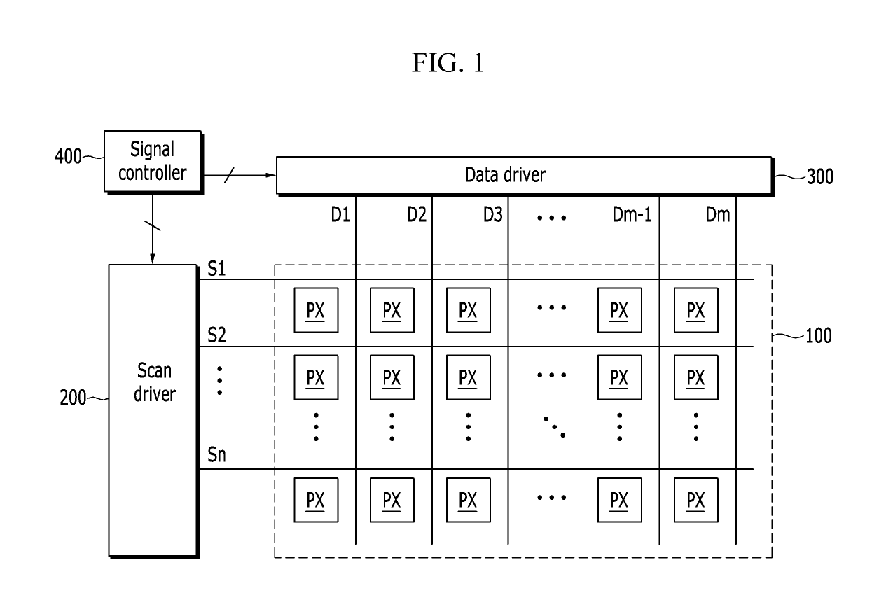

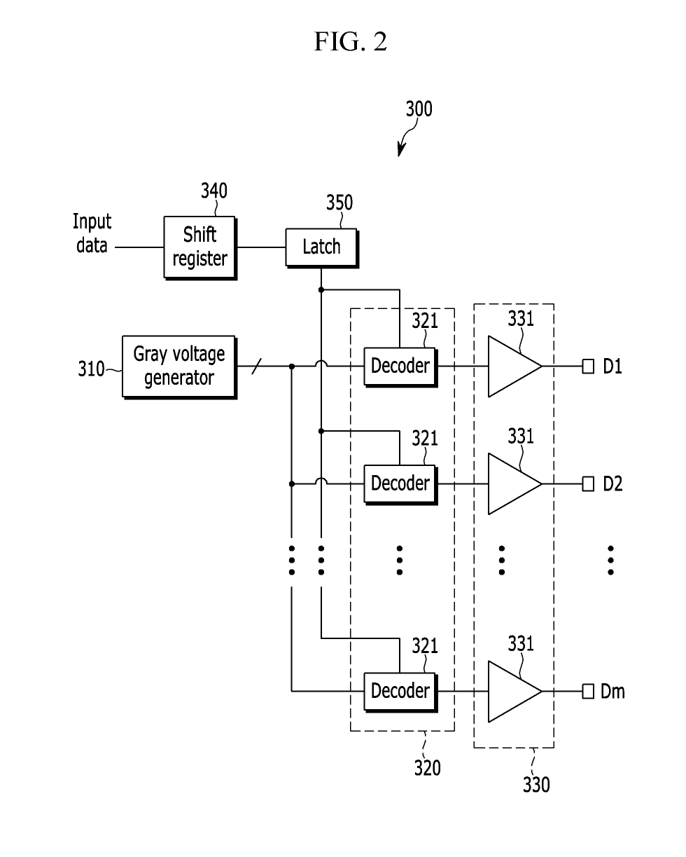

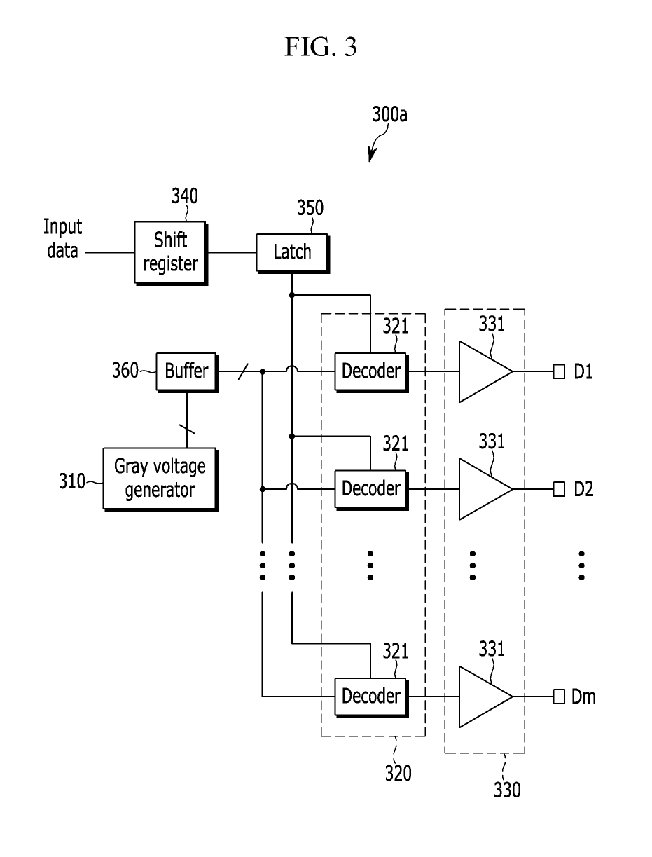

FIG. 1 shows a block diagram of a display device according to an exemplary embodiment, and FIG. 2 and FIG. 3 respectively show a block diagram of a data driving device according to an exemplary embodiment.

Referring to FIG. 1, the display device includes a display unit 100, a scan driver 200 and a data driver 300 connected thereto, and a signal controller 400 for controlling the scan driver 200 and the data driver 300.

In an exemplary embodiment, the display unit 100 includes a plurality of display signal lines (S₁-Sₙ, D₁-Dₘ) and a plurality of pixels (PX) connected thereto and substantially arranged in a matrix form. The display unit 100 may include a lower display plate and an upper display plate (not shown).

The display signal lines (S₁-Sₙ, D₁-Dₘ) include a plurality of scan lines (S1-Sn) for transmitting a scan signal (also called a gate signal) and data lines (D1-Dm) for transmitting a data signal. The scan lines (S1-Sn) are substantially extended in a row direction and are substantially parallel with each other, and the data lines (D1-Dm) are substantially extended in a column direction and are substantially parallel with each other.

The scan driver 200 is connected to the scan lines (S1-Sn) and applies a scan signal formed by combination of a gate-on voltage and a gate-off voltage to the scan lines (S1-Sn). The gate-on voltage represents a voltage that is applied to a gate of a transistor to turn on the transistor, and the gate-off voltage represents a voltage that is applied to the gate of the transistor to turn it off.

The data driver 300 is connected to the data lines (D1-Dm), generates a data signal for indicating a grayscale value of the pixel (PX), and applies it to the data lines (D1-Dm).

The signal controller 400 controls the scan driver 200 and the data driver 300.

Further, the pixel (PX) may include a transistor (not shown) that includes a gate connected to the scan line and a source and a drain connected to the data line that transmits the data signal provided by the data line in response to the gate-on voltage provided by the scan line, and a light emitting region (not shown) for expressing the grayscale according to the data signal provided by the transistor. When the display device is a liquid crystal display (LCD), the light emitting region may include a capacitor for storing the data signal, and a liquid crystal layer for expressing the grayscale according to the data signal stored in the capacitor. When the display device is an organic light emitting device, the light emitting region may include a capacitor for storing the data signal, a driving transistor for transmitting a current according to the data signal stored in the capacitor, and an organic light emitting diode (OLED) for expressing the grayscale according to the current provided by the driving transistor.

The drivers 200, 300, and 400 may be respectively mounted on the display unit 100 as at least one integrated circuit chip, may be mounted on a flexible printed circuit film (not shown) and be attached to the display unit 100 as a tape carrier package (TCP), or may be mounted on an additional printed circuit board (not shown). Alternatively, the drivers 200, 300, and 400 may be integrated with the display unit 100 together with the signal lines (S₁-Sₙ, D₁-Dₘ) and the transistors. Also, the drivers 200, 300, and 400 may be integrated into a single chip, and in this case, at least one of them or at least one circuit element forming them may be provided outside the single chip.

Referring to FIG. 2, the data driver 300 of FIG. 1, that is, the data driving device, includes a gray voltage generator 310, a decoding unit 320, and a buffering unit 330.

The gray voltage generator 310 generates a plurality of gray voltages that correspond to a plurality of grayscale values. For example, the gray voltage generator 310 can generate voltages at respective nodes of a resistor column connected between a power for supplying a high voltage and a power for supplying a low voltage as gray voltages. When input data has N bits, the gray voltage generator 310 may generate 2^{N} gray voltages.

The decoding unit 320 is connected between an output terminal of the gray voltage generator 310 and an input terminal of the buffering unit 330 and includes a plurality of decoders 321 that correspond to a plurality of data lines (D1-Dm). The decoders 321 respectively select one of a plurality of gray voltages according to the input data that corresponds to the data line (Dᵢ) and output the gray voltages to the buffering unit 330.

The buffering unit 330 is connected between an output terminal of the decoding unit 320 and a plurality of data lines (D1-Dm) and includes a plurality of buffers 331 that correspond to a plurality of data lines (D1-Dm). The buffer 331 transmits the gray voltage provided by the corresponding decoder 321 to the corresponding data line (Dᵢ) as a data signal. For example, the buffer 331 may include an amplifier of a source follower type. The buffer 331 prevents the gray voltage from being influenced when the pixel (PX) starts an operation.

The data driver 300 may further include a shift register 340 and a latch 350 so as to transmit input data as shown in FIG. 2.

The shift register 340 sequentially shifts the input data provided by the signal controller 400 so that they may correspond to a plurality of data lines (D1-Dm). The latch 350 stores the input data shifted by the shift register 340 and transmits the input data to the corresponding decoder 321.

According to another exemplary embodiment shown in FIG. 3, a data driver 300a may further include a buffering unit 360 connected between the gray voltage generator 310 and the decoding unit 320. The buffering unit 360 may include a plurality of buffers connected to a plurality of gray voltages. Alternatively, the buffering unit 360 may include a plurality of buffers respectively connected to some of a plurality of gray voltages. The buffer transmits the corresponding gray voltage to the input terminal of the decoding unit 320.

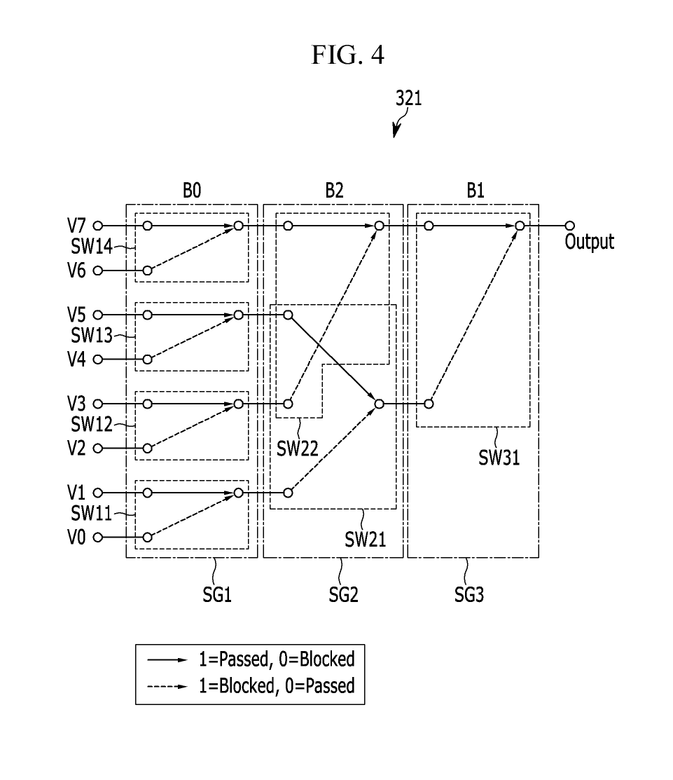

FIG. 4 shows a decoder of a data driver according to an exemplary embodiment.

Referring to FIG. 4, the decoder 321 is formed by a binary decoder, and it includes a plurality of switch groups (SG1), (SG2), and (SG3) coupled in series between an output terminal of the gray voltage generator 310 and an input terminal of the buffer 331. A plurality of switch groups (SG1), (SG2), and (SG3) respectively correspond to a plurality of bits of the input data. When the input data has N bits, N switch groups (SG1), (SG2), . . . , and (SGN) are provided. In FIG. N is assumed to be 3 for the purpose of illustration.

The first switch group (SG1) is connected to a plurality of gray voltage output terminals (V0-V7) for outputting a plurality of gray voltages, and it includes 2^{N-1} switches (SW11-SW14). Two input terminals (IN1) and (IN2) of the switch (SW1i) are connected to two corresponding gray voltage output terminals, and output one of the two gray voltages to the output terminal according to a least significant bit (LSB) (B0) of the input data. Particularly, the switch (SW1i) outputs the gray voltage of the input terminal (IN1) when the LSB (B0) is 0, and it outputs the gray voltage of the input terminal (IN2) when the LSB (B0) is 1. As shown in FIG. 4, the switch (SW11) is connected to the first and second gray voltage output terminals (V0) and (V1), the switch (SW12) is connected to the third and fourth gray voltage output terminals (V2) and (V3), the switch (SW13) is connected to the fifth and sixth gray voltage output terminals (V4) and (V5), and the switch (SW14) is connected to the (2^{N-1}−1)th and (2^{N-1})th gray voltage output terminals (V6) and (V7).

The second switch group (SG2) is connected to an output terminal of the first switch group (SG1), and it includes 2^{N-2} switches (SW21) and (SW22). Two input terminals (IN1) and (IN2) of the switch (SW2i) are connected to output terminals of the two switches in the first switch group (SG1), and they output one of the gray voltages output by the two switches to the output terminal according to a most significant bit (MSB) (B2) of the input data. Particularly, the switch (SW2i) outputs the gray voltage of the input terminal (IN1) when the MSB (B2) is 0, and it outputs the gray voltage of the input terminal (IN2) when the MSB (B2) is 1. As shown in FIG. 4, the switch (SW21) is connected to the output terminals of the first and (2^{N-2}+1)th switches (SW11) and (SW13), and the switch (SW22) is connected to output terminals of the (2^{N-2})th and (2^{N-1})th switches (SW12) and (SW14).

The N^{th} switch group (SG3) is connected to the output terminal of the (N−1)th switch group (SG2) and it includes a switch (SW31). Two input terminals (IN1) and (IN2) of the switch (SW31) are connected to the output terminals of the switches (SW21) and (SW22) of the (N−1)th switch group (SG2), and output one of the gray voltages output by the switch (SW21) and (SW22) to the output terminal according to a center bit (B1) of the input data. Particularly, when the bit (B1) is 1, the switch (SW31) outputs the gray voltage of the input terminal (IN1), and when the bit (B1) is 0, it outputs the gray voltage of the input terminal (IN2).

For example, when the input data is ‘010’, the first switch group (SG1) outputs gray voltages of gray voltage output terminals (V0, V2, V4, V6) according to the LSB of ‘0’, the second switch group (SG2) outputs output voltages of the first and second switches (SW11) and (SW12) of the first switch group (SG1) according to the MSB of ‘0’, that is, the gray voltages of the gray voltage output terminals (V0) and (V2), and the third switch group (SG3) outputs an output voltage of the second switch (SW22) of the second switch group (SG2), that is, the gray voltage of the gray voltage output terminal (V2) according to a middle bit of ‘1’. The decoder 321 can output the gray voltage that corresponds to the input data of ‘010’, that is, the gray voltage of the gray voltage output terminal (V2).

Further, N is assumed to be 3 in FIG. 4, and when N is generalized, bits of the input data are assigned to a plurality of switch groups in order of LSB, MSB, LSB+1, MSB−1, LSB+2, MSB−2, . . . , LSB+(MSB/2−1), and MSB-(MSB/2−1). For example, when 8-bit input data is used for expressing 256 grayscale values, the decoder includes eight switch groups, and the bits of the input data are allocated to the eight switch groups in order of LSB, MSB, LSB+1, MSB−1, LSB+2, MSB−2, LSB+3, and MSB−3.

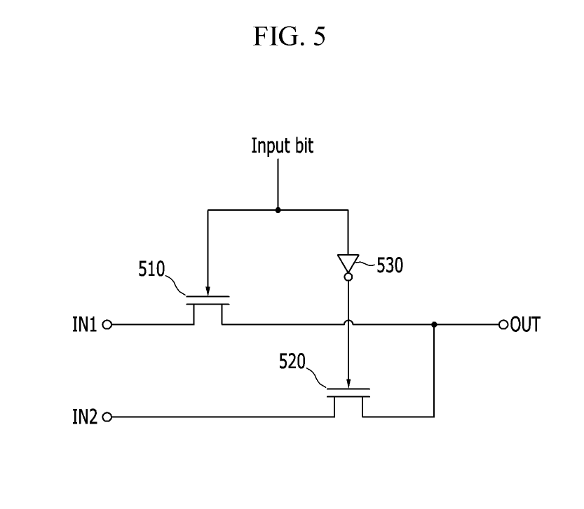

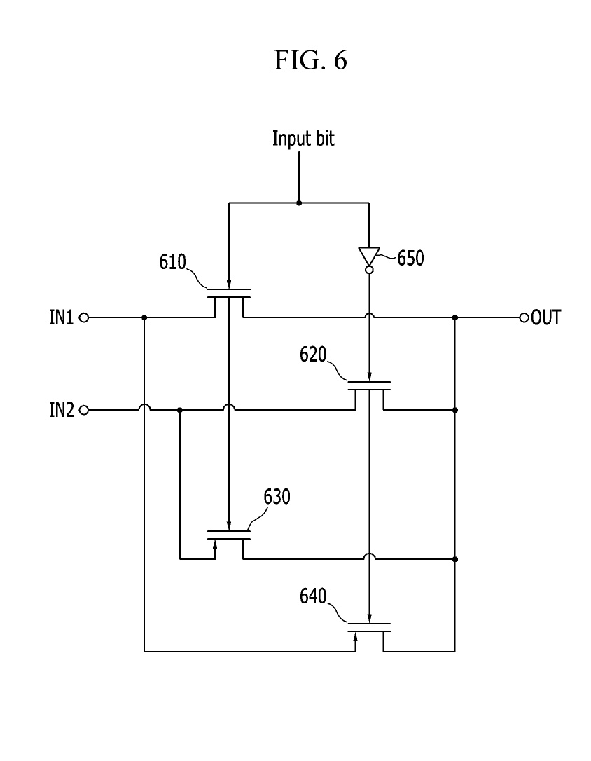

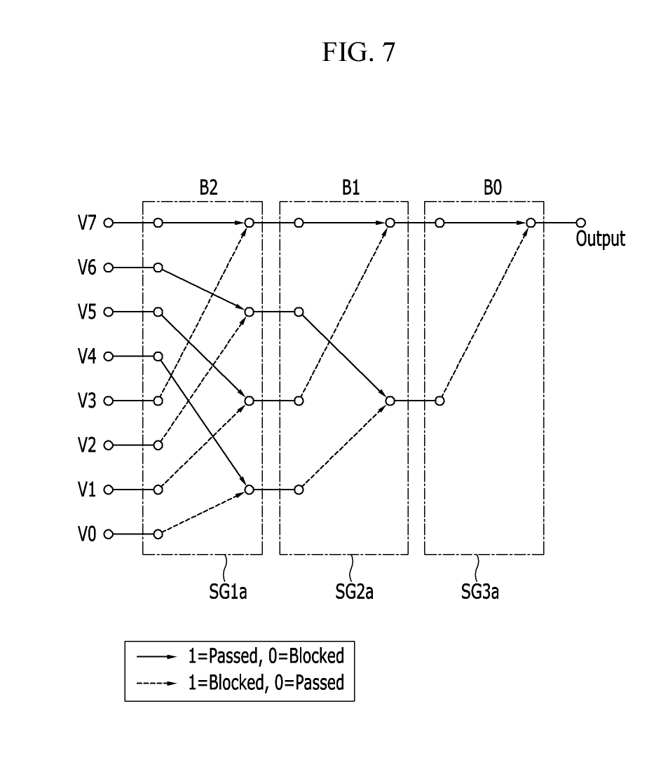

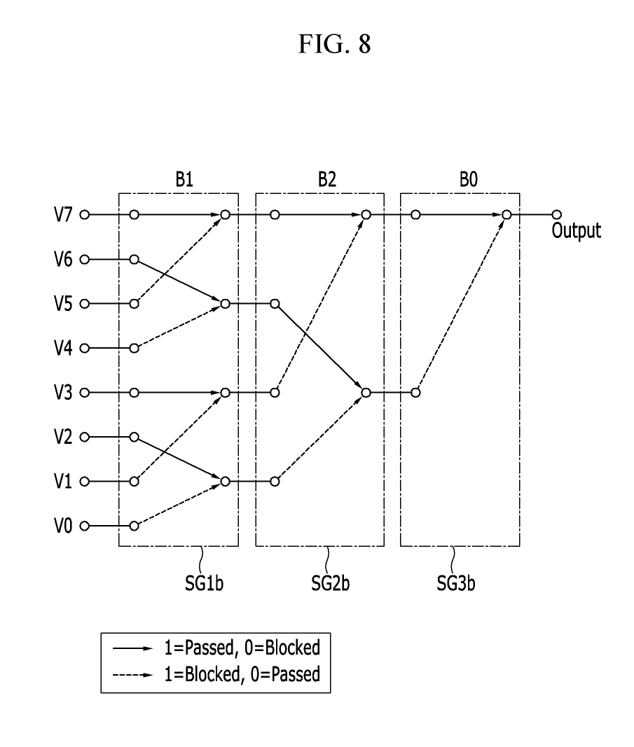

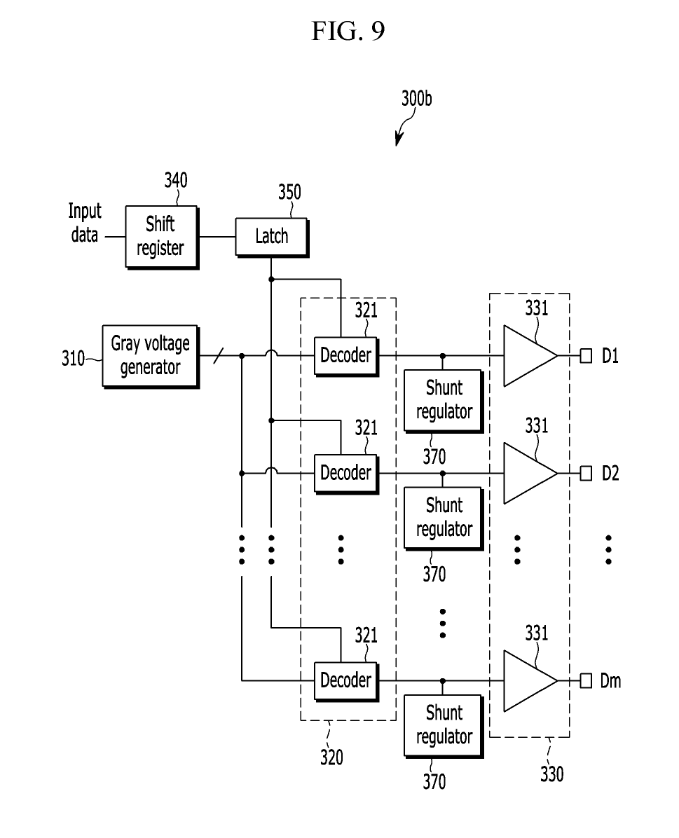

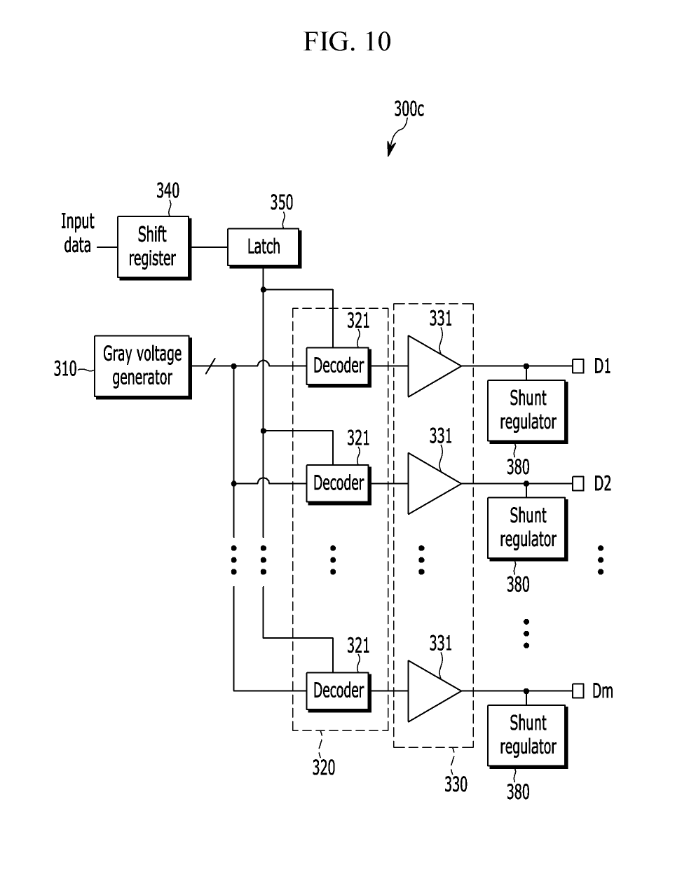

FIG. 5 shows an example of a switch included in a decoder shown in FIG. 4. FIG. 6 shows another example of a switch included in a decoder shown in FIG. 4.

Referring to FIG. 5, the switch includes two transistors 510 and 520. N-channel metal-oxide semiconductor (NMOS) transistors are shown for the two transistors in FIG. 5, but p-channel metal-oxide semiconductor (PMOS) transistors are also usable. Other implementation of switches using different circuit elements can also be used.

The input terminals of the transistors 510 and 520, for example, a source or a drain, respectively become the input terminals (IN1) and (IN2) of the switch, and the output terminals of the transistors 510 and 520, for example, a drain or a source, become the output terminal of the switch. The corresponding bit of the input data is inputted to a control terminal of the transistor 520, for example, a gate, and an inverted corresponding bit of the input data is input to a control terminal of the transistor 510. To invert the input bit, the switch groups of the decoder 321 may further include an inverter.

Therefore, when the corresponding bit of the input data is ‘1’, the transistor 510 is turned on and the voltage at the input terminal (IN1) is output to the output terminal (OUT), and when the corresponding bit of the input data is ‘0’, the transistor 520 is turned on and the voltage at the input terminal (IN2) is output to the output terminal (OUT).

Referring to FIG. 6, the switch can be implemented using NMOS transistors 610 and 620 and PMOS transistors 630 and 640.

The input terminals of the NMOS transistor 610 and the PMOS transistor 630 are coupled in parallel, for example, their sources or drains become an input terminal (IN1) of the switch. The input terminals of the NMOS transistor 620 and the PMOS transistor 640 are coupled in parallel, for example, their sources or drains can become another input terminal (IN2) of the switch. Also, the output terminals of the transistors (610, 620, 630, 640), for example, their drains or sources, can become the output terminals of the switch. The corresponding bits of the input data are inputted to the control terminals of the transistors 620 and 630, that is, gates, and inverted corresponding bits of the input data are inputted to the control terminals of the transistors 610 and 640. Each switch group of the decoder may include an inverter for inverting the input bit.

Therefore, when the corresponding bit of the input data is ‘1’, the transistors 610 and 640 are turned on and the voltage of the input terminal (IN1) is outputted to the output terminal. When the corresponding bit of the input data is ‘0’, the transistors 620 and 640 are turned on and the voltage of the input terminal (1N2) is outputted to the output terminal.

When the switch of FIG. 6 is used, a single switch requires four transistors except the inverter. For example, when the gray voltage (N=8) of 256 is used, the decoder 321 shown in FIG. 5 includes 1020 (=128×4+64×4+32×4+16×4+8×4+4×4+2×4+1×4) transistors. However, when a binary decoder of a different implementation than the exemplary embodiment is used, two transistors, for example, a combination of PMOS and NMOS transistors, are needed for each bit for a single gray voltage, so 4096 (=256×8×2) transistors are required.

As described according to the exemplary embodiments, the number of circuit elements of the decoder may be reduced to decrease the area of the data driving device. Therefore, the deviation between the gray voltages transmitted to the data line can be reduced.

FIG. 7 and FIG. 8 show a decoder of a data driver according to another exemplary embodiment.

Referring to FIG. 7, bits of the input data are allocated to a plurality of switch groups (SG1a-SG3a) of the decoder 321a in order of MSB, MSB−1, and LSB. FIG. 7 shows a case in which the MSB is 2. When N is generalized, bits of the input data are assigned to a plurality of switch groups in order of MSB, MSB−1, MSB−2, . . . , LSB+1, and LSB. For example, when 8-bit input data are input to express 256 grayscale values, the decoder 321a includes eight switch groups to which the bits of the input data are allocated in order of MSB, MSB−1, MSB−2, MSB−3, LSB+3, LSB+2, LSB+1, and LSB. In this case, the switch of the switching group (SG1a) that corresponds to the MSB (B2 of FIG. 7) has an i-th gray voltage output terminal and an (i+2^{MSB})th gray voltage output terminal as input terminals. The switch of the switching group (SG2a) that corresponds to the MSB−1 (B1 of FIG. 7) has a j-th output terminal and a (j+2^{MSB-1})th output terminal as input terminals.

Referring to FIG. 8, the bits of the input data are allocated to a plurality of switch groups (SG1b-SG3b) of a decoder 321b in order of MSB/2, MSB/2+1, and LSB. When N is generalized, the bits of the input data are allocated to a plurality of switch groups in order of MSB/2, MSB/2+1, MSB/2+2, . . . , MSB, LSB, LSB+1, LSB+2, . . . , (MSB/2−1). For example, when 8-bit input data are used to express 256 grayscale values, the decoder includes eight switch groups to which the bits of the input data are allocated in order of MSB/2, MSB/2+1, MSB/2+2, MSB/2+3, LSB, LSB+1, LSB+2, and LSB+3. In this case, the switch of the switching group (SG1b) that corresponds to the MSB/2 (B1 of FIG. 8) has an i-th gray voltage output terminal and an (i+2^{MSB/2})th gray voltage output terminal as input terminals.

FIG. 9 and FIG. 10 show block diagrams of a data driving device according to another exemplary embodiment.

Referring to FIG. 9, a data driving device 300b includes a plurality of shunt regulators 370. The plurality of shunt regulators 370 respectively correspond to a plurality of decoders 321. The shunt regulator 370 is connected to the output terminal of the corresponding decoder 321, and controls its output voltage so that the output voltage of the decoder 321 may stay close to its corresponding gray voltage.

Referring to FIG. 10, a data driving device 300c further includes a plurality of shunt regulators 380. The plurality of shunt regulators 380 respectively correspond to a plurality of buffers 331. The shunt regulator 380 is connected to the output terminal of the buffer 331, and controls its output voltage such that the output voltage of the buffer 331 may stay close to its corresponding gray voltage.

As described above, the number of the circuit elements of the decoder 321 is reduced, thereby reducing the area of the decoding unit 320. It is possible to control the voltage transmitted to the data line to be close to the gray voltage corresponding to that data line by installing a shunt regulator in the residual space of the data driving device.

What is claimed is:

1. A data driving device of a display device including a signal line electrically connected to a pixel, comprising:
a gray voltage generator for generating a plurality of gray voltages that correspond to a plurality of grayscale values;
a binary decoder for selecting from among the plurality of gray voltages a gray voltage that corresponds to an input data; and
a buffer including an input terminal electrically connected to an output terminal of the binary decoder and an output terminal electrically connected to the signal line.

2. The data driving device of claim 1, further comprising a shunt regulator electrically connected to an output terminal of the binary decoder.

3. The data driving device of claim 1, further comprising a shunt regulator electrically connected to an output terminal of the buffer.

4. The data driving device of claim 1, wherein
the input data is a plurality of bits,
the binary decoder includes an input switch group, at least one interposed switch group, and an output switch group; wherein the input switch group, the at least one interposed switch group and the output switch group are coupled in series between an output terminal of the gray voltage generator and an input terminal of the buffer, each switch group corresponding to the plurality of bits, and
the input switch group selects half of the gray voltages of the plurality of gray voltages and outputs the same to the at least one interposed switch group in response to a bit corresponding to the input switch group;
each switch group in the at least one interposing switch group selects half of the gray voltages of the plurality of gray voltages inputted from a previous switch group and outputs the selected gray voltages to a next switch group in response to a bit corresponding to the each switch group, and
the output switch group selects half of the gray voltages input from the at least one interposed switch group and outputs the selected gray voltage to the input terminal of the buffer in response to a bit corresponding to the output switch group.

5. The data driving device of claim 4, wherein
each switch group includes at least one switch that corresponds to two gray voltages, and
the switch selects one of the two gray voltages in response to the bit corresponding to the switch group.

6. The data driving device of claim 5, wherein the switch includes:
a first transistor electrically connected between a first input terminal for receiving a first gray voltage from among the two gray voltages and an output terminal, and the first transistor is turned on when the bit corresponding to the switch group is “1”; and
a second transistor electrically connected between a second input terminal for receiving a second gray voltage from among the two gray voltages and the output terminal, and the second transistor is turned on when the bit corresponding to the switch group is “0”.

7. The data driving device of claim 5, wherein the switch comprises:
a first n-channel transistor and a first p-channel transistor coupled in parallel between a first input terminal for receiving a first gray voltage from among the two gray voltages and an output terminal, and the first n-channel transistor and the first p-channel transistors are turned on when the bit corresponding to the switch group is “1”; and
a second n-channel transistor and a second p-channel transistor coupled in parallel between a second input terminal for receiving a second gray voltage from among the two gray voltages and the output terminal, and the second n-channel transistor and the second p-channel transistor are turned on when the bit corresponding to the switch group is “0”.

8. The data driving device of claim 4, wherein
the bits are in order of a least significant bit (LSB), a most significant bit (MSB), LSB+1, MSB−1, LSB+2, MSB−2, . . . , LSB+(MSB/2−1), and MSB-(MSB/2−1).

9. The data driving device of claim 4, wherein
the bits are in order of MSB, MSB−1, MSB−2, . . . , LSB+1, and LSB.

10. The data driving device of claim 4, wherein
the plurality of bits are in order of MSB/2, MSB/2+1, MSB/2+2, . . . , MSB, LSB, LSB+1, LSB+2, . . . , and (MSB/2−1).

11. A data driving device of a display device including a signal line connected to a pixel comprising:
a gray voltage generator for generating a plurality of gray voltages that correspond to a plurality of grayscale values;
a decoder for selecting a gray voltage from among the plurality of gray voltages that corresponds to an input data;
a buffer including an input terminal electrically connected to an output terminal of the decoder and an output terminal electrically connected to the signal line; and
a shunt regulator electrically connected between the output terminal of the decoder and the input terminal of the buffer.

12. The data driving device of claim 11, wherein
the input data is a plurality of bits,
the decoder includes an input switch group, at least one interposed switch group, and an output switch group; wherein the input switch group, the at least one interposed switched group and the output switch group are coupled in series between an output terminal of the gray voltage generator and an input terminal of the buffer, each switch group corresponding to the plurality of bits, and
the input switch group selects half of the gray voltages of the plurality of gray voltages and outputs the same to the at least one interposing switch group in response to a bit corresponding to the input switch group;
each switch group in the at least one interposed switch group selects half of the gray voltages of the plurality of gray voltages inputted from a previous switch group and outputs the selected gray voltages to a next switch group in response to a bit corresponding to the each switch group, and
the output switch group selects half of the gray voltages input from the at least one interposed switch group and outputs the selected gray voltage to the input terminal of the buffer in response to a bit corresponding to the output switch group.

13. The data driving device of claim 12, wherein
the bits are in order of a least significant bit (LSB), a most significant bit (MSB), LSB+1, MSB−1, LSB+2, MSB−2, . . . , LSB+(MSB/2−1), and MSB-(MSB/2−1).

14. The data driving device of claim 12, wherein
the bits are in order of MSB, MSB−1, MSB−2, . . . , LSB+1, and LSB.

15. The data driving device of claim 12, wherein
the bits are in order of MSB/2, MSB/2+1, MSB/2+2, . . . , MSB, LSB, LSB+1, LSB+2, . . . , and (MSB/2−1).

16. A display device comprising:
a pixel;
a signal line connected to the pixel;
a gray voltage generator for generating a plurality of gray voltages that correspond to a plurality of grayscale values;
a decoder for selecting a gray voltage from among the plurality of gray voltages that corresponds to an input data;
a buffer including an input terminal electrically connected to an output terminal of the decoder and an output terminal electrically connected to the signal line; and
a shunt regulator electrically connected between the output terminal of the decoder and the input terminal of the buffer.

17. The display device of claim 16, wherein
the input data is a plurality of bits,
the decoder includes an input switch group, at least one interposed switch group, and an output switch group; wherein the input switch group, the at least one interposed switch group and the output switch group are coupled in series between an output terminal of the gray voltage generator and an input terminal of the buffer, each switch group corresponding to the plurality of bits, and
the input switch group selects half of the gray voltages of the plurality of gray voltages and outputs the same to the at least one interposed switch group in response to a bit corresponding to the input switch group;
each switch group in the at least one interposing switch group selects half of the gray voltages of the plurality of gray voltages input from a previous switch group and outputs the selected gray voltages to a next switch group in response to a bit corresponding to the each switch group, and
the output switch group selects half of the gray voltages inputted from the at least one interposed switch group and outputs the selected gray voltage to the input terminal of the buffer in response to a bit corresponding to the output switch group.

18. The display device of claim 17, wherein
the bits are in order of a least significant bit (LSB), a most significant bit (MSB), LSB+1, MSB−1, LSB+2, MSB−2, . . . , LSB+(MSB/2−1), and MSB-(MSB/2−1).

19. The display device of claim 17, wherein
the bits are in order of MSB, MSB−1, MSB−2, . . . , LSB+1, and LSB.

20. The display device of claim 17, wherein
the bits are in order of MSB/2, MSB/2+1, MSB/2+2, . . . , MSB, LSB, LSB+1, LSB+2, . . . , and (MSB/2−1).
